(19) United States
(12) Patent Application Publication
(10) Pub. No.: US 2014/0151948 A1
(43) Pub. Date: Jun. 5, 2014

(54) Vertically Adjustable Work Station

(71) Applicant: MKIND, Inc., Manchester, NH (US)

(72) Inventor: Michael Kind, Manchester, NH (US)

(73) Assignee: MKIND, Inc., Manchester, NH (US)

(21) Appl. No.: 14/098,087

(22) Filed: Dec. 5, 2013

Related U.S. Application Data
(60) Provisional application No. 61/733,609, filed on Dec. 5, 2012.

(51) Int. Cl. B25H 1/14

(52) U.S. Cl. CPC B25H 1/14
USPC 269/58

(57) ABSTRACT

A vertically-adjustable work station is described. The work station includes a housing, a vertically-adjustable column, a work surface attached to the top of the column, and a motor to move the column vertically. In one embodiment, the work station is completely supported by a wall. In another embodiment, the work station is free from floor support.

### CROSS-REFERENCE TO RELATED APPLICATIONS

This application claims the benefit of U.S. Provisional Patent Application Ser. No. 61/733,609, filed Dec. 5, 2012, titled Vertically-adjustable Work Station, incorporated by reference herein and for which benefit of the priority date is hereby claimed.

### FIELD OF THE INVENTION

The present invention relates to work stations and, in particular, to a stable and vertically-adjustable work station that does not require floor support.

### BACKGROUND

Different types of work require the worker to adopt various body positions, such as sitting or standing. Height-adjustable work stations have been created to allow workers to adopt both sitting and standing postures. Such work stations often require a substantial amount of floor space for adequate support. Height-adjustable work stations have also been mounted on walls, specifically by utilizing a wall track. Such work stations are typically cantilevered and must be physically supported while raising or lowering the work station.

### SUMMARY

In one aspect a vertically-adjustable work station is provided, the work station being mounted at least two inches off of a floor and comprising a housing with at least one bracket fastened to the housing, a vertically-adjustable column mounted within the housing, a motor for adjusting the height of the column, and a work surface attached to the top of the column.

In another aspect, a vertically-adjustable work station is provided, the work station being fully supported by a wall, the work station comprising a housing mounted to the wall by at least one bracket, a vertically-adjustable column mounted inside the housing, a motor coupled to the column to facilitate vertical motion and a work surface attached to the top of the column.

Some aspects of possible embodiments may include one or more of the following: wherein the work station adjusts to a vertical height suitable for accommodating a worker in both a sitting and a standing position; wherein the work station can be adjusted by pressing two or more operational switches simultaneously; wherein the work station is mounted under a window.

Additional embodiments can include wherein the housing is not more than 22.25 inches in length and wherein the housing has exactly two brackets attached to it.

Further embodiments may include one or more of the following: wherein the work surface is outfitted with capabilities such as computer networking, docking, telephone availability and/or electrical charging; wherein the work surface is movable horizontally, wherein the work surface is rotatable horizontally; wherein the work surface is both movable horizontally and rotatable horizontally; wherein the work surface is adjustable within a range of 0 through 90 degrees with respect to an angle formed between the work surface and the column; and wherein the work surface is coated with an antimicrobial agent.

These aspects of the disclosure are not meant to be exclusive and other features, aspects, and advantages of the present invention will be readily apparent to those of ordinary skill in the art when read in conjunction with the appended claims and accompanying drawings.

### BRIEF DESCRIPTION OF DRAWINGS

The detailed description below may be better understood with reference to the accompanying figures which are provided for illustrative purposes and are not to be considered as limiting any aspect of the invention.

FIG. 1 provides an illustration of the prior art;

FIG. 2A provides a view of a work station wherein the column is collapsed within the housing;

FIG. 2B provides a view of a work station wherein the column is extended;

FIG. 3A provides a view of a work station mounted with one bracket;

FIG. 3B provides a view of a work station mounted with two brackets;

FIG. 3C provides a view of a bracket;

FIG. 3D provides an exploded view of a bracket mounted to the bottom of the housing;

FIG. 4 provides a view of a work surface adjusting through an angle range of 0-90 degrees; and

FIG. 5 provides an exploded view of a connector that may join the work surface to the column.

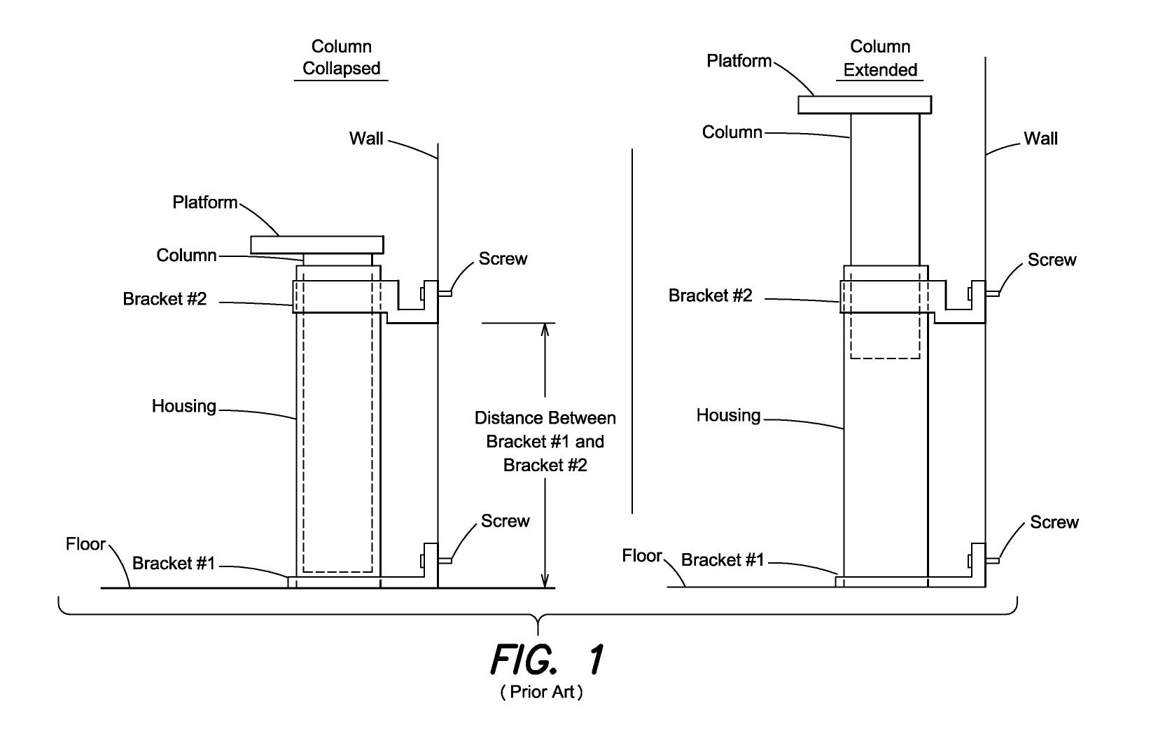

### DETAILED DESCRIPTION

Workers perform a variety of tasks throughout a working day. Many workers, especially in medical settings, adopt both sitting and standing postures for performing work. Having a work station with a height-adjustable work surface allows workers to utilize one work station for tasks requiring different body postures. Such height-adjustable units have gained popularity in the medical field, where many workers use the same work station for tasks requiring both sitting and standing postures.

Height-adjustable work stations can require a substantial amount of floor space for support. Such work stations are unsuitable for small spaces, especially where access to the floor is necessary for cleaning and disinfection purposes. Other height-adjustable work stations take up less floor space by being mounted on a track that is secured to a wall. Work stations which rely solely on a wall for support are typically cantilevered and are generally unstable and difficult to adjust. In the past, hospitals and other medical centers have relied on wall-track units as height-adjustable work stations, but these work stations must be supported physically while being adjusted, and can be challenging to adjust to specifically desired heights. Such units also tend to rock and/or bounce when force is applied. These unstable tendencies make such work stations unsuitable for delicate tasks or for work that requires force to be applied to the work station.

The present disclosure describes a vertically adjustable work station. In one set of embodiments the work station is solely supported by a wall and may be vertically adjustable. The work station may not require any floor space and may only utilize a minimal amount of wall space for mounting purposes. The work station's height can be adjusted to accommodate both sitting and standing workers, while still providing a stable surface for performing work. The height of the working surface can be adjusted simply by pressing operational switches.

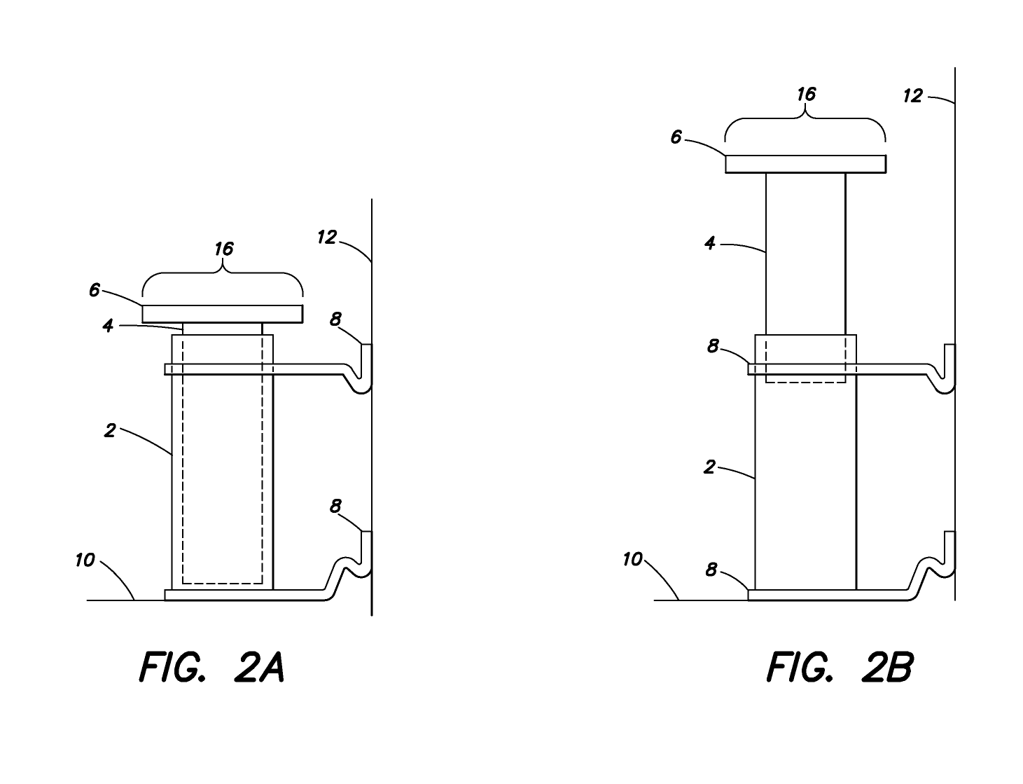

Referring to FIG. 2A and FIG. 2B, one embodiment of the present invention is shown. The work station 16 may include housing 2. Housing 2 may be made from a polymer, metal, composite or other structurally suitable material. As shown in FIG. 2A, housing 2 may be substantially hollow and may have a rectangular cross-section. However, other housing cross-section shapes may be desirable, such as cylindrical or oval. In a preferred embodiment, housing 2 has a length of not more than 22.25 inches, allowing housing 2 to be mounted in areas with minimal available vertical wall space, such as under a window. In another embodiment, housing 2 is mounted a distance off floor 10, such as two inches, four inches, or six inches, to allow floor 10 to be easily cleaned and sanitized. In some settings, an antimicrobial coating may be used to coat housing 2 to help keep housing 2 free of microbial contamination. Housing 2 may also be finished with an aesthetically-desirable finish that is suitable to the space in which work station 16 is placed. For example, housing 2 may have a finish of brushed metal, wood, paint, varnish, powder coating, or other decorative coating.

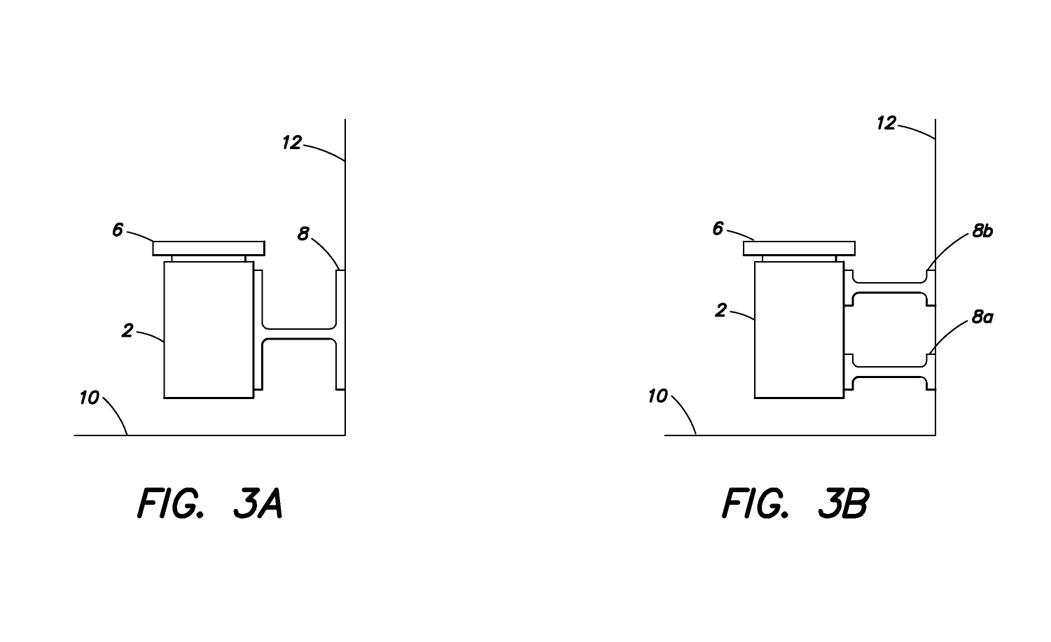

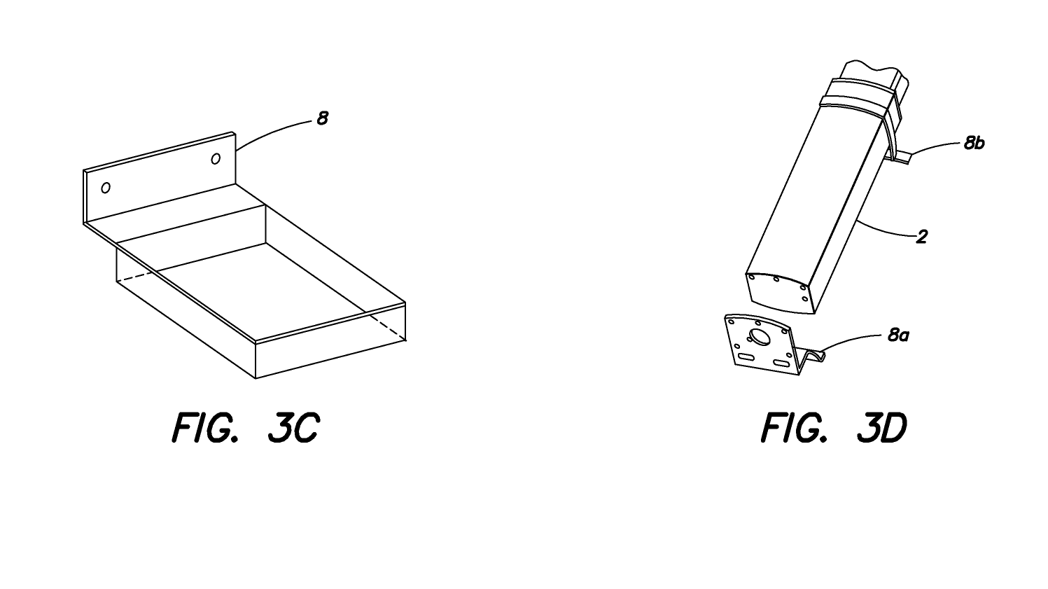

Housing 2 may have at least one bracket 8 that may be used to attach work station 16 to a wall. Bracket(s) 8 can be positioned along any portion of housing 2 such that work station 16 is fully supported by a wall 12 or not supported by a floor 10. Referring to FIG. 3A, one bracket 8 may be used to mount housing 2 to wall 12. Alternatively, two brackets may be used to mount work station 16 to wall 12, as is shown in FIG. 3B. Brackets 8a and 8b may be positioned along any portion of housing 2, provided that the spacing and alignment of the brackets allows work station 16 to be mounted off a floor. In one embodiment, bracket 8a may be attached to a bottom portion of housing 2 and bracket 8b may be mounted to a top portion of housing 2. When mounted into wall studs, such a configuration of brackets has allowed work station 16 to support up to 300 pounds. By mounting work station 16 off of a floor, the floor and surrounding environment can be more easily cleaned and disinfected. This may be particularly advantageous in a medical setting.

Bracket(s) 8 may be made of a metal or other suitable material such as polymer or composite. Bracket(s) 8 may be shaped to space housing 2 away from a wall 12 or alternatively can be shaped to place housing 2 directly against a wall 12. By mounting the housing away from the wall, space is made available for cleaning and disinfecting both the wall and the housing. Bracket(s) 8 may also be formed to wrap around a circumference of housing 2 as shown in FIG. 3C. Bracket(s) 8 may attach to a lower portion of housing 2 and support housing 2 from a bottom edge as shown in FIG. 3D. Bracket(s) 8 may be joined to housing 2 by welding, press fitting or with connectors, such as screws and/or bolts. Bracket(s) 8 may be secured to wall 12 with screws, bolts, or other fasteners.

Height-adjustable column 4 may be mounted inside housing 2 to allow work surface 6 to be vertically adjusted. In one set of embodiments, column 4 is operably attached to an electric motor, which moves column 4 vertically through housing 2. The motor may be integrated with the column via a rack and pinion system. The motor may be used to move the column 4 in both the upward and downward directions or may be used just to move the column 4 upward while disengaging the motor may allow column 4 to slide downward under the force of gravity. The motor may have operational switches that can be used to adjust the height of column 4. The motor's operating switches can be located in various places, for example, on a wall, on housing 2, or on work surface 6.

The motor may be configured to require two or more of the operational switches to engage simultaneously in order to move column 4 vertically. This functionality could ensure that work station 16 is not adjusted by accident. Alternatively, other mechanisms necessary to engage the motor may also be employed. For example, a motor may be restricted from engaging until an authorized person is detected proximal to the work station, for example when an RFID tag is detected. A motor could also be configured to cease operation, by entering a lock-out mode for example, if an unauthorized user attempts to manipulate the height of work station 16. The motor or lift may also be controlled by a microprocessor which raises or lowers the column 4 to a pre-selected height. This pre-selected height may be based on the height of a specific user and may be transmitted to the microprocessor wirelessly, for example by an RFID tag (identifying an individual, e.g.) or by a height detection system, such as an optically based height detection system. The system may also include a weight sensor and may be programmed to move vertically when a weight such as a laptop is removed from the work surface 6.

Column 4 can be shaped in a variety of ways. For example, column 4 may be substantially cylindrical or rectangular in cross-section. It may also have vertical grooves or ridges. Column 4 may be made of a metal, polymer, composite or other structural material. Column 4 may have a height greater than, equal to or less than housing 2. Work station 16 may be constructed to place the top surface of column 4 be in a plane with the top edge of housing 2 when column 4 is at its lowest possible vertical height. Alternatively, the column's top surface may be some distance above the top of housing 2 when column 4 is at its lowest possible vertical height. In some settings, an antimicrobial coating may be used to coat the column 4 in an effort to keep column 4 free of microbial contamination. Column 4 may also be coated with paint or another finish to obtain a desired aesthetic effect when work surface 6 is raised and column 4 is exposed.

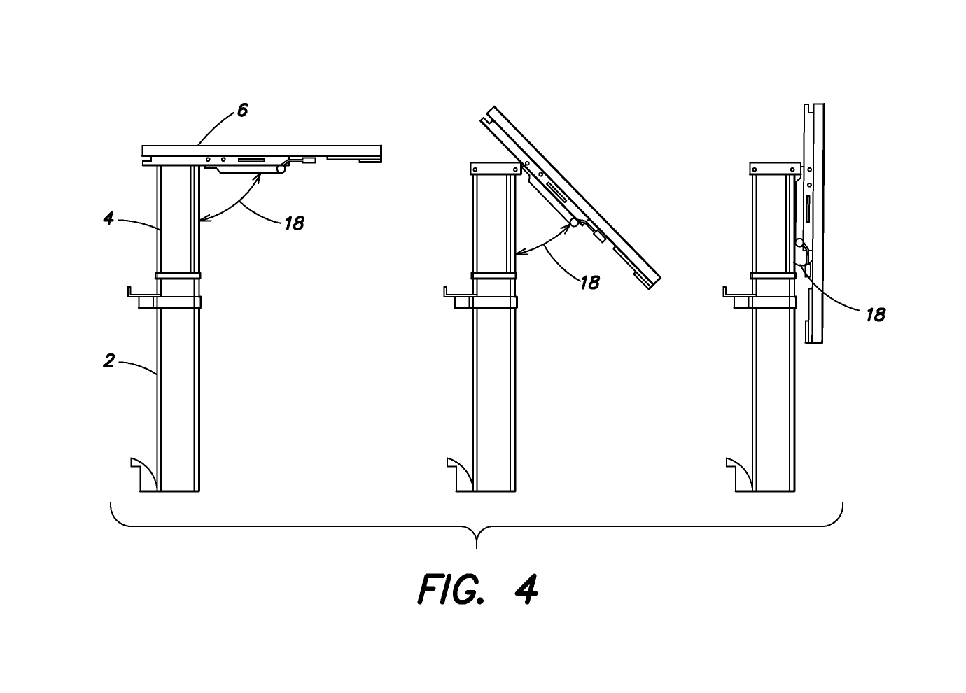

Work surface 6 may be attached to the top of column 4 in a variety of ways, for example, by gluing, welding, bolting, or with connectors. In one embodiment, work surface 6 may be attached to column 4 with a pivotable connector, as shown in FIG. 4. In such an embodiment, work surface 6 is mounted to column 4 with a joint that allows work surface 6 to adjust to different angles within an angle range. Angle 18, the angle formed between work surface 6 and column 4, may be adjustable within the range of 90 degrees through 0 degrees, as illustrated in FIG. 4. Such vertical angle adjustment capability would make work surface 6 available to a worker at more ideal orientations, thus allowing the worker to further adjust work surface 6 for a variety of tasks, such as writing, drawing, storing objects and/or reading.

Work surface 6 may be mounted on column 4 with a track-like connector, making work surface 6 moveable along an axis in a horizontal plane. Such movement capability can allow a worker to slide work surface 6 either closer or farther away while sitting or standing. Various configurations are suitable for providing the described movement of work surface 6, including a track-based configuration. In one such embodiment, a track may be mounted to a portion of column 4 to facilitate movement of work surface 6 along the track in a horizontal plane by allowing work surface 6 to slide back and forth horizontally on the track. In another embodiment, work surface 6 may be mounted on column 4 with a rotational connector that allows work surface 6 to rotate from 90° to 360° in a horizontal plane. In such an embodiment, work surface 6 may rotate in a horizontal plane when directed by a worker while still remaining attached to column 4.

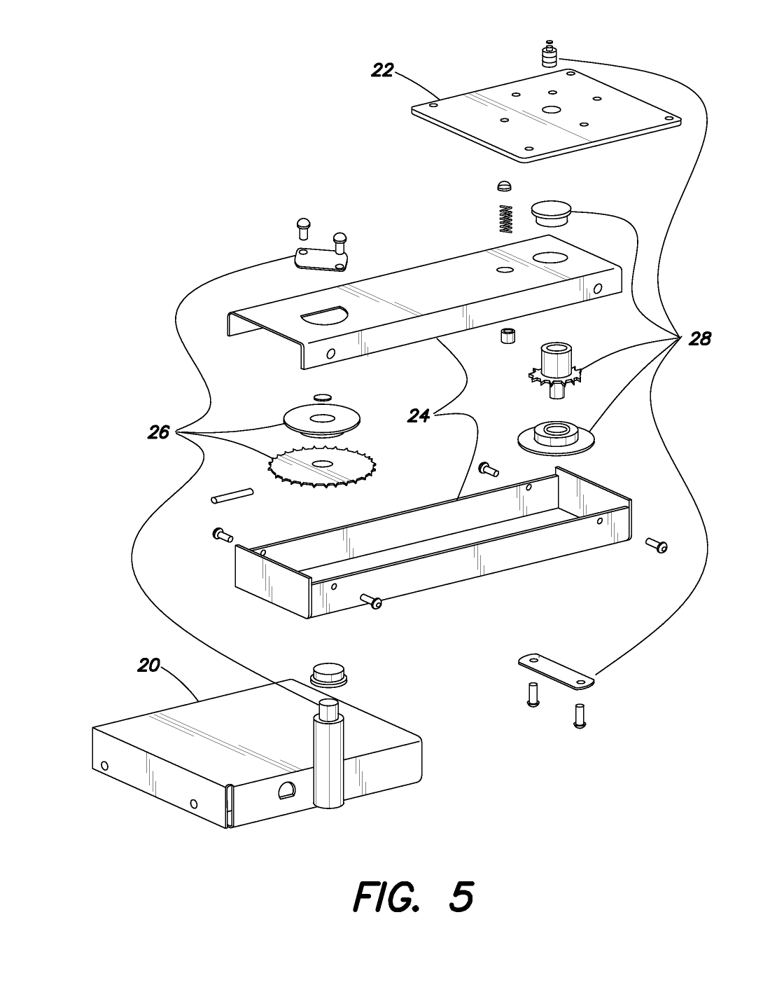

In yet another embodiment, workstation 16 may include connectors to allow work surface 6 to move along a horizontal axis and also to rotate in a horizontal plane. This “pull and swivel” mechanism may be accomplished, for example, by utilizing a connector as shown in FIG. 5. Such a connector may join column 4 to work surface 6. The connector shown in FIG. 5 may be employed by fastening the base of connector 20 to the top of column 4 and attaching the top of connector 22 to the base of work surface 6. As shown in FIG. 5, the connector may contain first rotation assembly 26, which allows work surface 6 to rotate in a horizontal manner when directed by a user. The connector may also contain second rotation assembly 28, which provides further horizontal rotation for work surface 6 when directed by a user. The connector also may include track assembly 24 to allow work surface 6 to be pulled by a user. The “pull and swivel” functionality the connector provides may allow work station 16 to accommodate even more body positions for workers, such as turning and reorienting the work surface while sitting or standing.

The “pull and swivel” functionality may also allow a user to rotate a work surface 90° from the original position of the work surface. The rotation may occur while the work surface remains in the same horizontal plane. Alternatively, the rotation may bring the work surface into a different horizontal plane than the horizontal plane of its original starting position. The rotation may occur in either a clockwise or counterclockwise direction. Also, if desired, the apparatus can be constructed to allow a user to rotate the work surface beyond 90°, such as 180° or any other desired angle, up to 360°. Such rotational capabilities could be especially useful in a medical setting. For example, a computer may be positioned on a work surface mounted to a wall. While the work surface is in a starting position, the user may manipulate the computer while the computer is parallel to the wall. If the user wishes to alter the direction in which the computer monitor is facing, the user may simply rotate the work surface by 90° or by 180°. Such a rotation could allow the user to face a patient while inputting or retrieving data. Further, the apparatus may have a range of possible rotation, and may include a built-in stopping angle, such as 90°, or additional stopping angles, such as 180°, to allow a user to lock the work station at desired rotational positions.

The outline of work surface 6 may take any one of a variety of shapes. For example, work surface 6 could be square, rectangular, circular, oval, or kidney-shaped. Work surface 6 may be manufactured from a variety of materials, including: metal, wood, plastic, laminate, or composite. Work surface 6 may also be finished with aesthetically-desired materials suitable for the work occurring at work station 16. For example, work surface 6 may be finished with brushed metal, wood, paint, varnish, powder coating, or other decorative finish.

Work surface 6 may be customized for the type of work occurring at the work station. For example, work station 16 may be outfitted with a computer docking station, computer network access, electrical power, and/or telephone capabilities. Work surface 6 may also have a flat portion for tasks such as writing. Alternatively, work surface 6 may incorporate trays for storing objects, such as office supplies or medical devices. Work surface 6 could also be outfitted with specialized storage devices, such as cup holders. In some settings, an antimicrobial coating may be used to coat work surface 6 to help keep work station 16 free of microbial contamination. For example, work surface 6 may be covered with AMO-400 antimicrobial film available from Madico.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

What is claimed is:

1. A work station comprising:
a housing suspended at least two inches from a floor;
at least one bracket fastened to the housing;
a vertically-moveable column mounted inside the housing;
a work surface attached to a top surface of the column; and
a motor secured to the housing, the motor capable of vertically adjusting the work surface.

2. The work station of claim 1 wherein the motor further comprises at least two operational switches, and moves the column vertically only when at least two of the operational switches are engaged simultaneously.

3. The work station of claim 1 wherein the work surface further comprises an interface for at least one of the following capabilities: computer networking, docking, telephone and electrical power.

4. The work station of claim 1 wherein the work surface is movable along an axis in a horizontal plane.

5. The work station of claim 1 wherein the work surface is rotatable in a horizontal plane.

6. The work station of claim 1 wherein the work surface is movable along an axis in a horizontal plane and rotatable in the horizontal plane.

7. The work station of claim 1 wherein the work surface forms an angle with the column, the angle being adjustable through a range of 0 through 90 degrees.

8. The work station of claim 1 wherein the housing has a length not more than 22.25 inches.

9. The work station of claim 1 wherein the work station comprises a first bracket attached to a first portion of the housing, and a second bracket attached to a second portion of the housing.

10. The work station of claim 1 further comprising an antimicrobial coating on the work surface.

11. A work station comprising:
a housing fully supported by a wall;
at least one bracket fastened to a portion of the housing and to the wall;
a vertically-moveable column mounted inside the housing;
a motor for moving the column vertically within the housing; and
a work surface mounted to a top surface of the column.

12. The work station of claim 14 wherein the motor further comprises at least two operational switches, and the motor moves the column vertically only when at least two of the operational switches are engaged simultaneously.

13. The work station of claim 14 wherein the work surface further comprises an interface for at least one of the following capabilities: computer networking, docking, telephone and electrical power.

14. The work station of claim 14 wherein the work surface is movable along an axis in a horizontal plane.

15. The work station of claim 14 wherein the work surface is rotatable in a horizontal plane.

16. The work station of claim 14 wherein the work surface is moveable along an axis in a horizontal plane and rotatable in the horizontal plane.

17. The work station of claim 14 wherein the work surface forms an angle with the column and the angle is adjustable through a range of 0 through 90 degrees.

18. The work station of claim 14 wherein the housing has a length not more than 22.25 inches.

19. The work station of claim 14 wherein the work station contains a first bracket attached to a first portion of the housing and to the wall, and a second bracket attached to a second portion of the housing and to the wall.

20. The work station of claim 14 further comprising an antimicrobial coating on the work surface.
